(19) United States
(12) Patent Application Publication
(10) Pub. No.: US 2004/0231788 A1
(43) Pub. Date: Nov. 25, 2004

(54) Laser joining method for structured plastics

(76) Inventors: Jie-Wei Chen, Alpnach Dorf (CH); Andreas Danzer, Kerns (CH)

Correspondence Address: BACHMAN & LAPOINTE, P.C., 900 CHAPEL STREET, SUITE 1201, NEW HAVEN, CT, 06510, US

(21) Appl. No.: 10/848,491

(22) Filed: May 18, 2004

(30) Foreign Application Priority Data
May 22, 2003 (EP) 03 011 610.7

(51) Int. Cl. B32B 31/00

(52) U.S. Cl. 156/272.8

(57) ABSTRACT

Laser joining method for connecting different workpieces by the transmission welding method. The laser beam is formed in such a way that the energy density of the laser radiation along the direction of propagation is dependent on the distance from the laser source. A beam constriction in which the maximum energy density is located is produced. A contact surface between the workpieces is arranged in such a way that it is located in the region of high energy density. The plastics material outside the zone of the beam constriction is not effectively heated. The method permits the mass production of welded structured workpieces.

### BACKGROUND OF THE INVENTION

The present invention relates to a laser joining method for connecting different workpieces made of plastic or for connecting plastic to different materials, the upper workpiece, facing the laser source, consisting of a material which is transparent for the laser beam and the second workpiece consisting of a material which is absorbent for the laser beam, so that the mutually adjacent contact surfaces of the two workpieces melt and bond to one another during the subsequent cooling under pressure.

Such a method is known for example from EP-A1-997 261. In the case of this method, a curtain-like laser beam is directed at the workpieces, the region which is not to be heated being covered by means of a mask. With the known method, structured and non-structured workpieces are connected. Welding of the two workpieces is intended to take place only at the touching contact surfaces, so that for this reason a corresponding mask is used.

The welding of plastics by means of a laser beam requires controllable metering of the thermal energy. The decisive factor for this metering is the energy density and the duration of the irradiation, which determine the quickness of the heating-up process and the maximum achievable temperature of the plastic.

Welding over a surface area with desired welding structures, corresponding to the workpieces, can be realized by the known mask welding principle mentioned above. In this case, the desired surface area is passed over with a curtain-like laser radiation, which traces a line on the welding plane, the energy metering being controlled by the laser power and the scanning speed. The spatial distribution of the thermal energy is determined by the mask, because with a curtain-like radiation the energy density remains virtually unchanged along the direction of propagation of the light. Therefore, the locations on the component that lie at a different height and are not to be irradiated must be covered by a mask. It goes without saying that the same also applies to a laser beam in the form of a spot which is scanned over the corresponding surface area at high speed.

In the case of the known method, use of the mask is sometimes disadvantageous, since it necessitates an adjustment and, because of this, the throughput of components is low.

Accordingly, it is an object of the present invention to provide a method for joining together structured workpieces according to a laser transmission welding method so as to provide a high throughput.

### SUMMARY OF THE INVENTION

The foregoing object is achieved according to the invention by providing a laser joining method for connecting different workpieces made of plastic or for connecting plastic to different materials, the upper workpiece, facing the laser source, consisting of a material which is transparent for the laser beam and the second workpiece consisting of a material which is absorbent for the laser beam, so that the mutually adjacent contact surfaces of the two workpieces melt and bond to one another during the subsequent cooling under pressure, at least the second workpiece having a structured surface with lower-lying surface regions, facing the other workpiece, and the laser beam and the components being moved in relation to one another, wherein the laser beam is focused by an optical system in such a way that the energy density is at a maximum in the region of the contact surfaces and the melting of the material of the second workpiece takes place only at the contact surfaces, the contact surfaces and the lower-lying surface regions being irradiated by the laser beam and the workpieces being melted and connected to one another only in the region of the contact surfaces.

By the method according to the invention, the laser beam is focused by means of an optical system in such a way that the energy density is at a maximum in the region of the contact surfaces. Depending on the application, in this case the optical system is chosen, by appropriate selection of the lenses, in such a way that the cross section of the region is larger or smaller. This setting has the effect that the melting of the material of the second workpiece takes place only at the contact surfaces, although the contact surfaces and the lower-lying surface regions are irradiated by the laser beam. As a result, the workpieces are melted and connected to one another only in the region of the contact surfaces. Consequently, structured welding of the contact surfaces takes place without a mask. As far as the laser beam is concerned, it is important that the region of higher energy density is adequate to achieve fusion of the two workpieces and can be set in the direction of propagation, seen from the laser source. For desired fusion, it is important that the structure height d is very much greater than the height h of the region of maximum energy density. Then, for example with a short range of high energy density, the structure can be chosen to be correspondingly small, at least in the second workpiece, which is not transparent for the laser beam, without softening of the lower-lying structures taking place, since the energy density is not adequate there. In the most favorable case, this region of maximum energy density is merely a surface area.

A laser beam with a beam constriction of high energy density is advantageously used, since this permits a high energy density in just a small region in a way corresponding to the stipulations mentioned above. The height h and the width b of the beam constriction are preferably set in accordance with the regions to be welded in the structured second workpiece, which is not transparent for the laser beam.

According to a development of the method, the laser beam is generated by means of a cylindrical lens. The linear laser beam is projected by a cylindrical convergent lens only on the focal plane of the lens. This means that the energy density of the laser radiation along the direction of propagation is dependent on the distance from the laser source. The maximum energy density is located in the beam constriction. The geometry of this beam constriction (height h and width b) is dependent on the optical aperture and the focal length of the lens. The greater the angle of convergence and the shorter the focal length, the thinner the beam constriction. The thickness of the beam constriction may also be referred to as the thickness of the zone of sharp image projection.

In the case of a structured workpiece, the figure of the welding seam is determined only by the surface-area structure on the focal plane if the difference in height of the structures is significantly greater than the thickness of the beam constriction.

### BRIEF DESCRIPTION OF THE DRAWINGS

The invention is explained in more detail below on the basis of exemplary embodiments in conjunction with the accompanying drawings, in which:

FIG. 1 shows a basic diagram for the welding of two plastic workpieces;

FIG. 2 shows the enlarged representation of a beam constriction;

FIG. 3 shows the basic construction with a standard diode laser; and

FIG. 4 shows the basic construction with the laser beams being fed in via a light guide.

### DETAILED DESCRIPTION

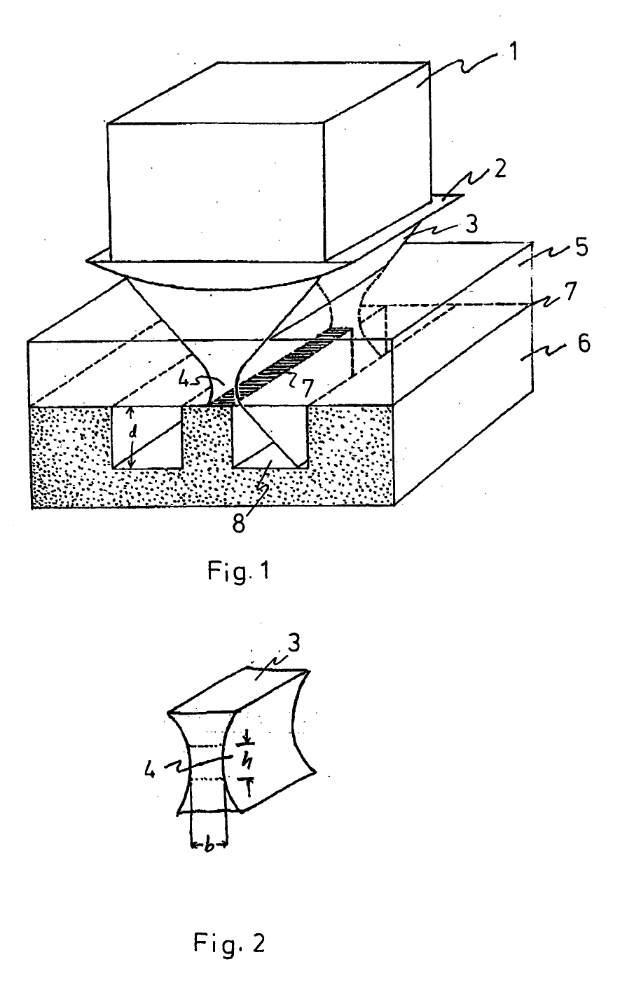

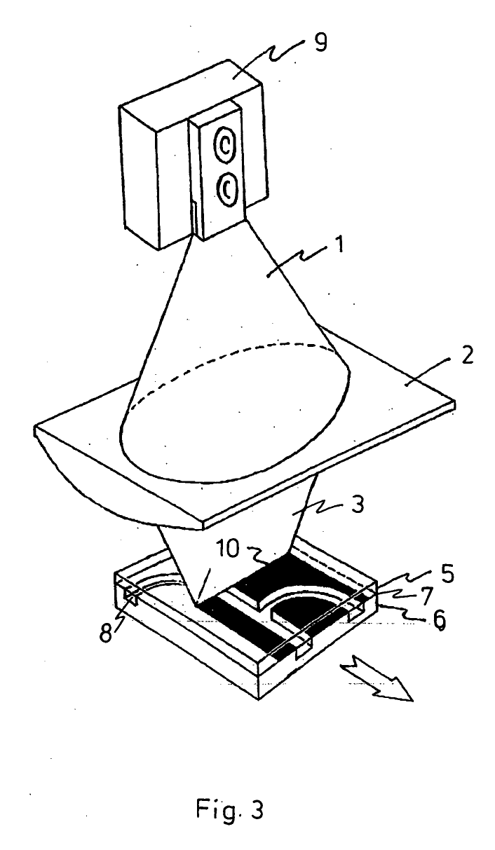

FIG. 1 shows in an enlarged representation a prepared laser beam 1, which impinges on a cylindrical lens 2. The cylindrical lens 2 reshapes the laser beam 1 into a laser beam 3, which varies in energy density in the direction of propagation. This has the effect that the laser beam does not have the same width or the same diameter throughout in longitudinal section, the regions of high energy density being distinguished by a smaller diameter or smaller beam width in comparison with the regions of lower energy density. In the exemplary embodiment, the laser beam 3 is shaped in such a way that it has a beam constriction 4. In FIG. 2, the laser beam 3 is represented once again, in an enlarged form, in the region of the beam constriction 4. Shown in the figure are the width b and the height h of the beam constriction 4, which can be influenced by corresponding optical measures. The width b defines the smallest width of the laser beam 3. The height h defines the length of the region with the smallest width b.

FIG. 1 further shows a first workpiece 5, which is transparent for the laser beam, and a second workpiece 6, which is located thereunder and not transparent for the laser radiation. For the purposes of illustration, the workpiece 5 has been drawn in the figure as transparent, although this does not mean that this workpiece cannot likewise be colored. The workpiece 6 has a structure with lower-lying surface regions 8 in comparison with the contact surfaces 7, which regions 8 are not to be softened by the laser beam 3. Contrary to the representation in FIG. 1, the transparent workpiece 5 may likewise have a structure, as already shown in the prior art. In this case, however, no surface of the lower workpiece 6 may be covered by the upper workpiece 5, since this leads to inappropriate heating. FIG. 1 reveals that the region of high energy density around the beam constriction 4 is located in the region of the contact surfaces 7. The shaping of the laser beam 3 has the effect that the energy density in the region of the lower-lying surface regions 8 is not adequate to melt them. Consequently, softening only takes place in the region of the contact surfaces, so that the two workpieces 5, 6 are connected in this region in the known way. By contrast with the prior art, it therefore makes no difference if the laser beam also irradiates the lower-lying surface regions. As a consequence, a mask is not required. What is important is that the workpieces 5, 6 are arranged with their contact surface 7 in the region of the beam constriction 4. Changing the height h and the width b allows the laser beam to be adapted to the geometrical shapes of the structures in the workpieces 5, 6.

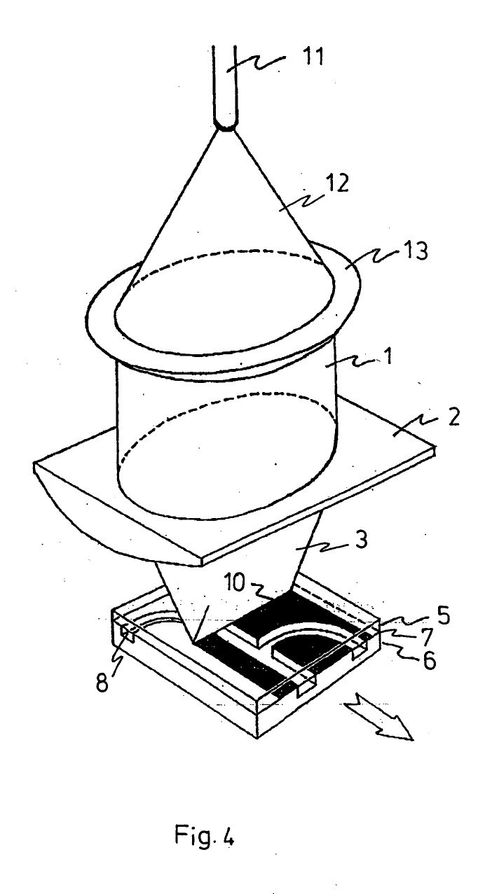

FIG. 3 shows in a schematic representation a standard diode laser 9, which brings a conical laser beam 1 onto the cylindrical lens 2. As described in connection with FIG. 1, the cylindrical lens 2 reshapes the laser beam 1 into the laser beam 3, which is then moved over the surface region 10 to be welded, without regard to the lower-lying surface regions 8. It is pointed out that the surface region 10 to be welded does not have to coincide with the entire surface of the workpieces. It is also clear that what ultimately matters is the relative movement between the workpieces 5, 6 and the laser beam 3. In the exemplary embodiment, the workpieces 5, 6 are moved.

In the exemplary embodiment according to FIG. 4, the laser beam 12 emerging in a conical form from a light guide 11 is guided to the cylindrical lens 2 via a spherical convergent lens 13.

In the exemplary embodiment, a linear laser beam and the workpieces are moved in relation to one another. In a corresponding way it is also possible to generate instead of the laser line a laser spot, which then has to be guided correspondingly for irradiation over a surface area.

1. A laser joining method for connecting different workpieces (5, 6) made of plastic wherein an upper workpiece (5), facing the laser source, comprises a material which is transparent for a laser beam (3) and a second workpiece (6) comprises a material which is absorbent for the laser beam (3), wherein mutually adjacent contact surfaces (7) of the two workpieces (5, 6) melt and bond to one another during the subsequent cooling under pressure, at least the second workpiece (6) has a structured surface with lower-lying surface regions (8), facing the other workpiece (5), and the laser beam (3) is moved in relation to one another, the method comprises the steps of focusing the laser beam (3) by means of an optical system wherein energy density is at a maximum in the region of the contact surfaces (7) and the melting of the material of the second workpiece (6) takes place only at the contact surfaces (7), the contact surfaces (7) and the lower-lying surface regions (8) being irradiated by the laser beam and the workpieces (5, 6) being melted and connected to one another only in the region of the contact surfaces (7).

2. The method as claimed in claim 1, wherein the height (h) and the width (b) of the beam constriction (4) produced by the focusing is set in accordance with the structure of the workpieces (5, 6) to be welded.
